(19) United States
(12) Patent Application Publication
(10) Pub. No.: US 2015/0382197 A1
(43) Pub. Date: Dec. 31, 2015

(54) NETWORK-BASED RESTRICTION OF SENSITIVE COMMUNICATIONS

(71) Applicant: Verizon Patent and Licensing Inc., Arlington, VA (US)

(72) Inventors: Dahai Ren, Lincoln, MA (US); Ming Chen, Bedford, MA (US)

(21) Appl. No.: 14/319,618

(22) Filed: Jun. 30, 2014

(51) Int. Cl. H04W 12/08; H04L 29/06

(52) U.S. Cl. CPC H04W 12/08; H04L 63/10; H04L 63/20

(57) ABSTRACT

Techniques described herein may provide for the restriction of certain communications. The communications to restrict may be determined by communication restriction policies. The policies may be resolved based on the location of a user, time, the occurrence or non-occurrence of certain events, or other factors. In one implementation, a method may include receiving a request from a mobile device to establish a communication session; evaluating a communication restriction policy to determine whether conditions associated with the communication restriction policy are satisfied, the conditions including at least one condition relating to an event occurring externally to the network; and restricting the communication session.

### BACKGROUND

Some companies, such as financial institutions, may be legally restricted as to the types of information that employees, of the companies, are permitted to disclose. For example, information that is “material non-public information” may be prohibited, by regulation, from being disclosed.

To enforce the non-disclosure regulations, a company may require employees to sign an agreement not to abuse material non-public information. Additionally, the company may set rules relating to turning off of personal communication devices when working Requiring employees to turn off personal communication devices can be inconvenient for employees, however, as the employees may rely on the personal communication devices.

### BRIEF DESCRIPTION OF THE DRAWINGS

FIG. 1 is a diagram illustrating an example of an overview of concepts described herein;

FIG. 2 is a diagram of an example environment in which systems and/or methods described herein may be implemented.

FIGS. 3A and 3B illustrate example data structures relating to the application of communication restriction policies for mobile devices;

FIG. 4 is a flowchart illustrating an example of a process relating to network-based restriction of communications;

FIG. 5 is a flowchart illustrating an example of a process relating to network-based restriction of communications according to an additional implementation;

FIG. 6 is a flowchart illustrating an example of a process relating to configuring indication restriction policies for network-based restriction of communications;

FIG. 7 is a diagram illustrating an example user interface provided by a mobile device;

FIG. 8 is a diagram illustrating operations associated with the application of communication restriction policies;

FIG. 9 is a diagram illustrating additional example operations associated with the application of communication restriction policies; and

FIG. 10 is a diagram of example components of a device.

### DETAILED DESCRIPTION OF PREFERRED EMBODIMENTS

The following detailed description refers to the accompanying drawings. The same reference numbers in different drawings may identify the same or similar elements.

Techniques described herein may provide for the restriction of certain communications. The communications to restrict may include communications that are determined, based on policies set by a corporation (or other entity), to be potentially sensitive. The policies may be resolved based on the location of a user (e.g., a policy may only be applicable when an employee is at the physical location of the workplace), a current time, the occurrence or non-occurrence of certain events, or other factors. The communications that are restricted may include, for example, voice calls, text-based communications, and/or video communications. The restrictions to apply to the communications may include, for example, blocking, recording, and/or monitoring of the communications.

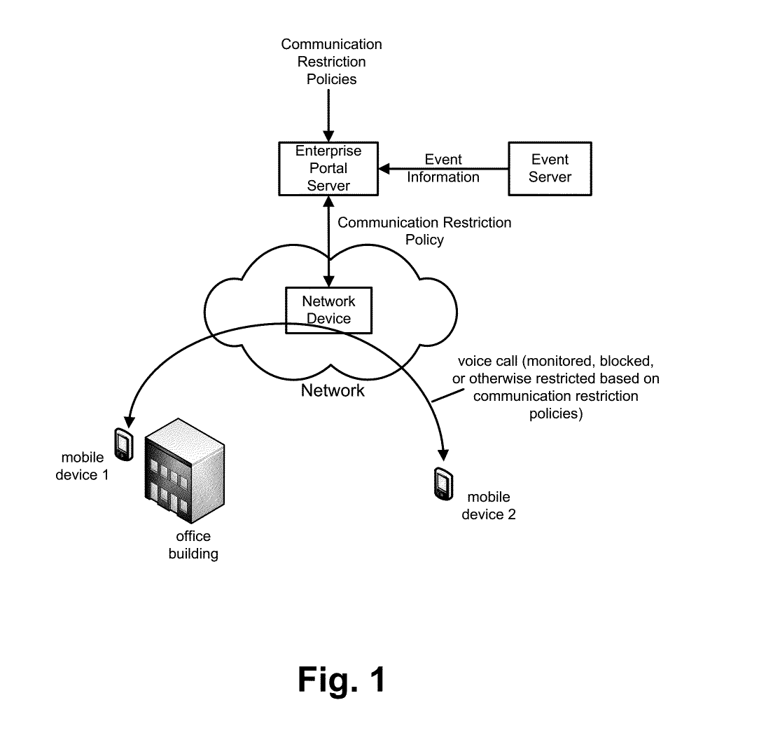

FIG. 1 is a diagram illustrating an example of an overview of concepts described herein. As illustrated, a network, such as a wireless network, may provide connectivity to mobile devices, such as mobile telephones or smart phones. Assume that a first mobile device (“mobile device 1”) is associated with an employee that is at work at an office building of the employee's employer (“office building”). Mobile device 1 may be the personal mobile device of the employee. As part of the conditions of employment, the employee may have previously agreed to allow monitoring of the employee's communications, using mobile device 1, while the employee is at work. The employer may be particularly concerned about disclosure of material non-public information, by the employee, relating to the business of the employer.

Further assume that, while at the office building, the employee wishes to place a voice call (“voice call”) with a user of a second mobile device (“mobile device 2”). The employer may have previously provided one or more communication restriction policies to an enterprise portal server. The enterprise portal server may be, for example, a server device provided by an operator of a wireless network. Assume the employer has entered a communication restriction policy that indicates that if mobile device 1 is in the vicinity of the office building, then communications of the employee are to be monitored.

Real-time decisions relating to whether to restrict communications may be made by network devices (“network device”) associated with the network. For example, in the context of a Long Term Evolution (LTE) cellular network, the network device may be a mobility management entity (MME) or policy and charging rules function (PCRF) that communicates with the enterprise portal server to determine the particular communication restriction policies to employ and/or to determine a set of mobile devices that are to have communications restricted at any particular time. For this example, in which the communication restriction policy may be to record communications involving mobile device 1 when mobile device 1 is in a vicinity the office building, assume that mobile device 1 is determined, by the network device, to be in the restricted geographical area (i.e., in the vicinity of the office building). The network device may then initiate recording of the voice call. In some implementations, whenever a communication is monitored or recorded, an indication, such as an audio sound (e.g., a periodic beep) or visual indication (e.g., a popup box) may indicate, to the parties associated with the communication, that the communication is being monitored/recorded.

In some implementations, the communication restriction policies may include policies that are based on the use of external information that is obtained from one or more information sources (illustrated as an event server in FIG. 1). As an example of a communication restriction policy based on an external event, assume that the employer specifies a communication restriction policy that blocks all communications before a certain time period of the release of scheduled financial information. In this scenario, the external event may thus be an indication that financial information is to be released at a certain date/time. If the employee, associated with mobile device 1, attempts to communicate with the user of mobile device 2 (e.g., via a voice call) within the certain time period of the release of the scheduled financial information, the network device may determine that this communication is to be blocked and may corresponding block or otherwise interrupt the communication. In some implementations, a message, such as an audio or text message, may be transmitted to the initiator of the communication to indicate that the communication has been blocked.

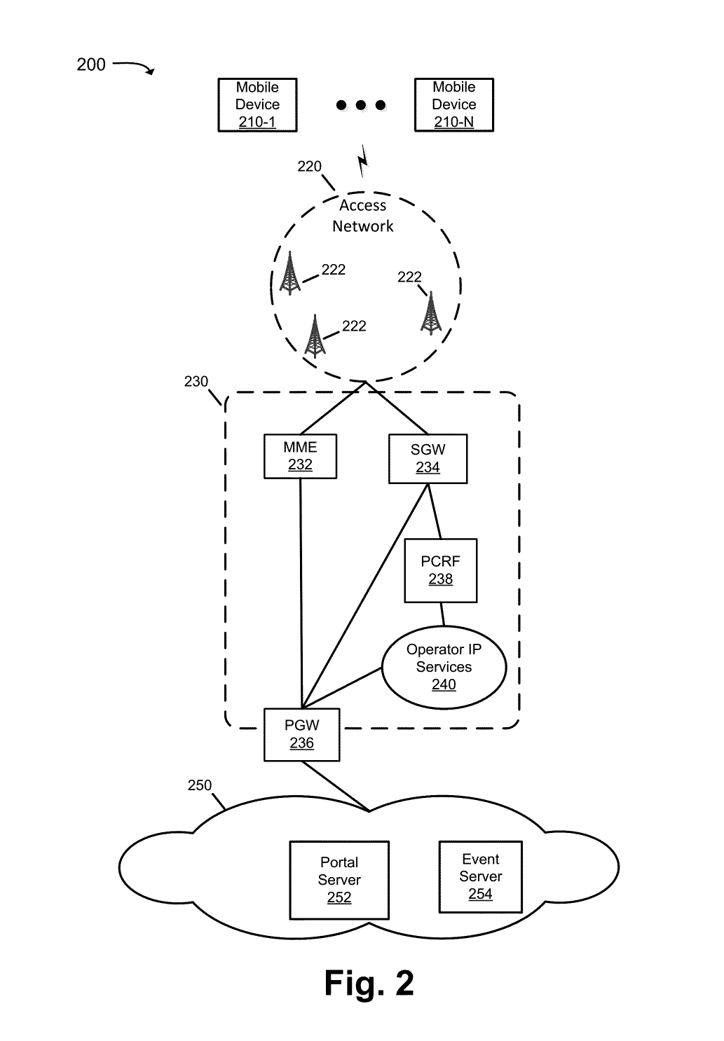

FIG. 2 is a diagram of an example environment 200 in which systems and/or methods described herein may be implemented. As shown in FIG. 2, environment 200 may include one or more mobile devices 210-1 through 210-N (where N is an integer greater than or equal to one, hereinafter sometimes referred to individually as “mobile device 210” and collectively as “mobile devices 210”), access network 220, core network 230, and external network 250. Access network 220 and core network 230 may together represent a wireless network, such as a cellular wireless network. Access network 220 may be associated with a network operator that controls or otherwise manages core network 230. In one implementation, core network 230 may include an Internet Protocol (IP)-based network, such as System Architecture Evolution (SAE) core network or a General Packet Radio Service (GPRS) core network.

Mobile device 210 may include a portable computing and communication device, such as a personal digital assistant (PDA), a smart phone, a cellular phone, a laptop computer with connectivity to a cellular wireless network, a tablet computer, etc. Mobile device 210 may also include non-portable computing devices, such as desktop computers, consumer or business appliances, or other devices that have the ability to wirelessly connect to access network 220.

Access network 220 may represent a wireless access network, such as a 3rd Generation Partnership Project (3GPP) LTE access network, that includes one or more access technologies. Access network 220 may include base stations 222. In the context of an LTE-based access network, base stations 222 may be referred to as evolved NodeBs (eNodeBs). Base stations 222 may each provide a radio interface over which the eNodeB may communicate with mobile device 210. The radio interface may include a radio interface that implements, for example, an Evolved Terrestrial Radio Access Network (E-UTRAN).

Core network 230 may include mobility management entity (MME) 232, serving gateway (SGW) 234, packet data network gateway (PGW) 236, policy charging and rules function (PCRF) 238, and operator IP services 240. In some implementations, various ones of the elements illustrated in core network 230, such as MME 232 and SGW 234, may alternatively be implemented as part of or considered to be part of access network 220.

MME 232 may include one or more computation and communication devices that perform operations to register mobile device 210 with core network 230, establish bearer channels associated with a session with mobile device 210, hand off mobile device 210 from one base station to another, implement network traffic policies, and/or perform other operations. MME 232 may generally handle control plane traffic. SGW 234 may include one or more network devices that aggregate traffic received from one or more base stations 222. SGW 234 may generally handle user (data) plane traffic.

PGW 236 may include one or more devices that act as the point of interconnect between core network 230 and external network 250 and/or operator IP services 240. PGW 236 may route packets to and from the access network 220 and external network 250. PCRF 238 may operate in real-time to determine policy rules for the network. PCRF 238 may aggregate information to and from core network 230, operational support systems, and other sources. PCRF 238 may support the creation of rules and policy decisions for active subscribers. The rules and policy decisions may include communication restriction policies that relate to restricting certain communications.

Operator IP services 240 may represent one or more services that are offered by the operator of core network 130. The services may include IP multimedia (IMS)-based services, transparent end-to-end packet-switched streaming services (PSSs), or other services.

External network 250 may include an IP-based network or other network. For example, external network may include a local area network (LAN), a wide area network (WAN), a metropolitan network (MAN), an intranet, the Internet, a fiber optic-based network, and/or a combination of these or other types of networks. External network 250 may include, or be associated with, a number of computing devices, illustrated as portal server 252 and event server 254.

Portal server 252 may include one or more computing devices, such as a server device or a collection of server devices. A “server device,” as used herein, may broadly include a hardware and/or software implemented computing device designed to receive and respond to requests from other computing devices. A server device may be or include a database or other file structure. In one implementation, portal server 252 may be maintained by an operator of core network 230. Portal server 252 may function to provide an interface through which users, such as administrators associated with corporations or other entities, may manage communication restriction policies. Portal server 252 may, for example, allow users, associated with corporations, to upload and edit communication restriction policies relating to employees of the corporation. Portal server 252 may communicate with one or more devices associated with core network 230, such as MME 232 and/or PCRF 238, to enforce the communication restriction policies within core network 230. For example, MME 232 and/or PCRF 238 may, at various times, communicate with portal server 252 to obtain updated versions of the communication restriction policies.

Event server 254 may include one or more computing devices, such as a server device or a collection of server devices, that acts as a source of external information (“events”) relating to the communication restriction policies. Although illustrated as a single device in FIG. 2, event server 254 may represent a number of external information sources. In one implementation, event server 254 may provide information that may be relevant to the determination of whether communication restriction policies, relating to material non-public information in the financial sector, are triggered. Event server 254 may provide information to portal server 252 and/or to another device, such as MME 232 or PCRF 238. For example, event server 254 may provide information relating to stock prices of public companies, information relating to news or press releases associated with companies, information associated with Securities and Exchange Commission (SEC) filings, information relating to prices of publicly traded options relating to companies, or other information. In some implementations, event server 254 may provide analysis services and may generate alerts based on the result of the analysis service. For example, event server 254 may monitor the stock prices of a public company and may generate an alert when unusual price activity or unusual volume activity is detected. In general, event server 254 may allow for communication restriction policies to be enforced based on an occurrence of real-time or near real-time events.

Although portal server 252, event server 254, and computing device 256 are illustrated as being implemented as part of external network 250, in some implementations, these devices may be implemented outside of external network 250 or as part of core network 230.

The quantity of devices and/or networks, illustrated in FIG. 2, is provided for explanatory purposes only. In practice, there may be additional devices and/or networks; fewer devices and/or networks; different devices and/or networks; or differently arranged devices and/or networks than illustrated in FIG. 2. Alternatively, or additionally, one or more of the devices of environment 200 may perform one or more functions described as being performed by another one or more of the devices of environment 200.

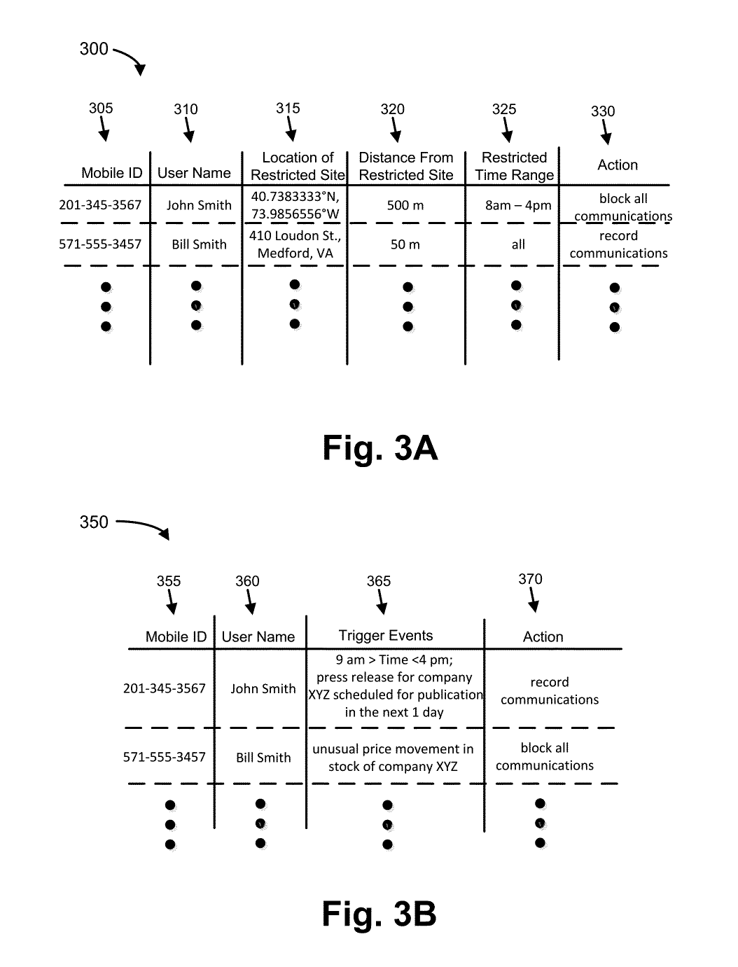

FIGS. 3A and 3B illustrate example data structures 300 and 350, respectively, relating to the application of communication restriction policies for mobile devices 210. Data structures 300 and 350 may be maintained by, for example, portal server 252 or another device.

Data structure 300 may be used with communication restriction policies in which communications, associated with mobile device 210, are to be restricted based on time of day and based on the location of the mobile device (e.g., with respect to the workplace of the user of the mobile device). As illustrated, data structure 300 may include a number of fields, including: mobile device identification (ID) field 305, user name field 310, location of restricted site field 315, distance from restricted site field 320, restricted time range field 325, and action field 330. The fields shown for data structure 300 are examples. In alternative possible implementations, different, fewer, or additional fields may be implemented.

Mobile device identification (ID) field 305 may include one or more values that uniquely identify a particular mobile device. For example, mobile device identification field 305 may include a mobile directory number (MDN), an International Mobile Subscriber Identity (IMSI) value, an International Mobile Station Equipment Identity (IMEI), a media access control (MAC) number, or other values that may be used to identify a particular mobile device. User name field 310 may include the name of the user associated with mobile device 200, an account name associated with mobile device 210, or some other value related to the account associated with mobile device 210.

Location of restricted site field 315 may include information identifying the geographical location of the restricted site. The restricted site may include the workplace (or workplaces) associated with the user of mobile device 210. Alternatively or additionally, the restricted site may include other locations. The information associated with location of restricted site field 315 may include coordinate information (e.g., latitude/longitude values), postal address information, or other information that may correspond to a particular location or area. Distance from restricted site field 320 may store a value indicating a distance, from the location indicated in location of restricted site field 315, in which the communication restriction policies are to be enforced. In the illustrated example, location of restricted site field 315 and distance from restricted site field 320 effectively define a circular area over which the communication restriction policies are to be enforced. Alternatively or additionally, other techniques may be used to define the area. For example, a series of coordinate values (e.g., latitude and longitude values) may be used to define a polygon in which the communication restriction policies are to be enforced. Restricted time range field 325 may include one or more time or date ranges during which the communication restriction policies are to be enforced.

Action field 330 may define the substantive communication restriction policies to take when the conditions for a communication restriction policy are satisfied. Possible actions may include: blocking the communication, recording the communication and/or monitoring the communication, and/or automatically inserting messages in the communications (e.g., for a voice call, inserting a warning that disclosure of material non-public information is prohibited).

Two example records are shown for data structure 300. The first record applies to the MDN number “201-345-3567” (field 305) and the user “John Smith” (field 310). The communication restriction policy for this MDN may be to block all communications associated with the mobile device when the mobile device is within 500 meters (field 320) of the geographical coordinate “40.7383333° N, 73.9856556° W” (field 315) and when the time is between 8 AM and 4 PM (field 325). Similarly, the second record applies to the MDN number “571-555-3457” (field 305) and the user “Bill Smith” (field 310). The communication restriction policy for this MDN may be to record communications associated with the mobile device (field 330) when the mobile device is within 50 meters (field 320) of the address “410 Loudon St., Medford, Va.” (field 315).

Referring to FIG. 3B, data structure 350 may be used with communication restriction policies in which communications, associated with mobile device 210, are to be restricted based on trigger events that may include information relating to external events, such as events output by event server 254. As illustrated, data structure 350 may include a number of fields, including: mobile device identification (ID) field 355, user name field 360, trigger events field 365, and action field 370. The fields shown for data structure 350 are examples. In alternative possible implementations, different, fewer, or additional fields may be implemented.

Mobile device identification field 355 may be similar to mobile device identification field 305 and may include one or more values that uniquely identify a particular mobile device. User name field 360 may be similar to user name field 310 and may include the name of the user associated with the mobile device, an account name associated with mobile device, or some other value related to the account associated with the mobile device.

Trigger events field 365 may include one or more conditions relating to the application of communication restriction policies. Trigger events field 365 may include conditions such as those that were discussed with respect to data structure 300, including time periods and geographical areas for which a communication restriction policy is active. Trigger events field 365 may additionally include restrictions associated with other information, such as events received from event server 254.

Action field 370 may define the substantive communication restriction policies to take when the conditions for a communication restriction policy are satisfied. Action field 370 may be similar to action field 330, and may include possible actions such as: blocking the communication, recording the communication and/or monitoring the communication, and/or automatically inserting messages in the communications (e.g., for a voice call, inserting a warning that disclosure of material non-public information is prohibited).

Two example records are shown for data structure 350. The first and second record correspond to the same MDN numbers (field 355) and user names (field 360) as the corresponding records of data structure 300. The communication restriction policy for the first record (MDN “201-345-3567”) may be to record all communications associated with the mobile device (field 370) when the time is between 9 AM and 4 PM and when a press release for a particular company (company “XYZ”) is scheduled to be released within the next day (field 365). The indication of whether a press release is scheduled for publication in the next day may be received as event information from event server 254. The communication restriction policy for the second record (MDN “571-555-3457”) may be to block all communications associated with the mobile device (field 370) whenever unusual price movement is detected in the stock of company XYZ (field 365). The indication of whether unusual price movement is occurring, in the stock of a particular company, may be received as event information from event server 254.

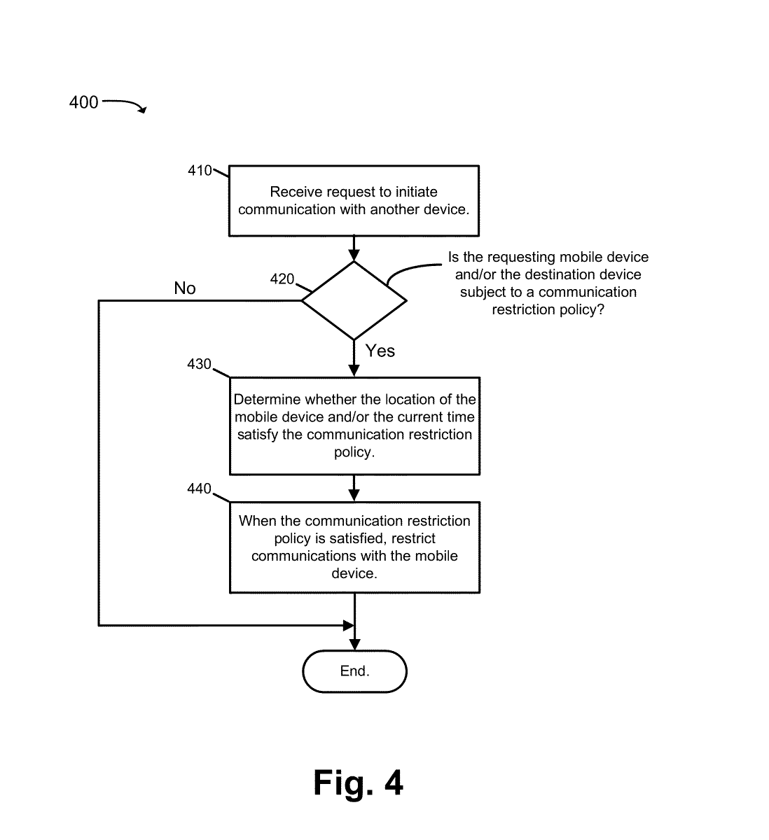

FIG. 4 is a flowchart illustrating an example of a process 400 relating to network-based restriction of communications. Process 400 may be performed by, for example, MME 232, PCRF 238, and/or portal server 252.

Process 400 may include receiving a request to initiate communication with another device (block 410). The request may include, for example, request to initiate a voice call (e.g., via voice over IP services), a video call, a text message, an instant messaging session, or some other form of communication. The request may be received at one or more network devices associated with core network 230, such as MME 232 or PGW 236.

Process 400 may further include determining, such as by the network device that receives the request, whether the requesting mobile device and/or the destination device are subject to a communication restriction policy (block 420). As previously mentioned, the communication restriction policies may be created by a company or other entity that is authorized to restrict communications for the mobile device. The communication restriction policies may be uploaded or otherwise provided to portal server 252. The network device that receives the communication request may access portal server 252 (either in response to the request or at a previous instance) to receive relevant communication restriction policy. In one implementation, communication restriction policies may be defined on a per-mobile device (e.g., per-MDN basis). In this situation, block 420 may correspond to determining whether the MDN of one of the devices involved in the communication request are subject to a communication restriction policy.

Process 400 may further include, when the mobile device is determined to be subject to a communication restriction policy (block 420—Yes), determining whether the location of the mobile device and/or the current time satisfy the communication restriction policy (block 430). In this implementation, the communication restriction policy may be a policy defined based on a location of mobile device 210 (e.g., a geographic area of mobile device 210) and based on time periods for which the communication restriction policy is active. For example, as shown in FIG. 3A, the communication restriction policy may be satisfied when mobile device 210 is within a certain distance of a particular coordinate location (e.g., 500 meters of a location) and the current date/time is within a particular range (e.g., weekdays between 8 AM and 4 PM).

Process 400 may further include, when the communication restriction policy is satisfied, restricting communications with the mobile device (block 440). As previously mentioned, restricting communications may include one or more of: blocking the communication, recording the communication and/or monitoring the communication, and/or automatically inserting messages in the communications. For example, when a voice call is determined to be blocked, MME 232 may drop the voice call. In some implementations, different communication policy actions may be taken based on whether the mobile device that is subject to the communication restriction policy is the initiator of the communication. For example, all voice calls placed by a particular mobile device may be blocked but voice calls received by the particular mobile device may be modified to included a recorded warning, at the beginning of the call, indicating that material non-public information should not be discussed. The blocking, recording, monitoring, and/or modifying the communication sessions may be performed by one or more of the network elements in core network 230. For example, for VoIP calls, operator IP services 240 may perform the recording, monitoring, and/or modifying the VoIP sessions.

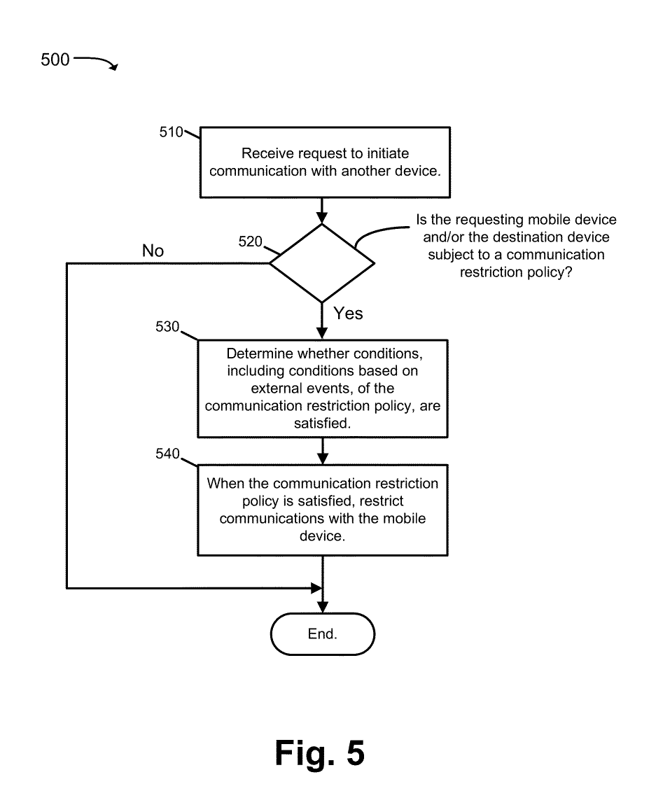

FIG. 5 is a flowchart illustrating an example of a process 500 relating to network-based restriction of communications according to an additional implementation. Process 500 may be performed by, for example, MME 232, PCRF 238, and/or portal server 252.

Process 500 may include receiving a request to initiate communication with another device (block 510). The request may include, for example, a request to initiate a voice call (e.g., via voice over IP services), a video call, a text message, an instant messaging session, or some other form of communication. The request may be received at one or more network devices associated with core network 230, such as MME 232 or PGW 236.

Process 500 may further include determining, such as by the network device that receives a request, whether the requesting mobile device and/or the destination device are subject to a communication restriction policy (block 520).

Process 500 may further include, when the mobile device is determined to be subject to a communication restriction policy (block 520—Yes), determining whether conditions of the communication restriction policy are satisfied (block 530). The conditions may include conditions that depend on the occurrence of external events (block 530). For example, and as previously mentioned, an indication of the incurrence of external events may be received from one or more external sources (illustrated as event server 254 FIG. 2), such as financial news sources, financial price data sources (e.g., stock or option exchanges), weather sources, sources that provide data on regulatory filings, etc. In one implementation, the external sources may include a particular signal or condition that is manually set by an administrator, such as by an administrator associated with a particular company. For example, in response to the discussion of sensitive company data (e.g., during merger talks with another company), a company officer may cause an external event to be input to portal server 252 that indicates “sensitive discussions.” One or more communication restriction policies, determined by the company, may depend on whether the “sensitive discussions” event is active for the company.

Process 500 may further include, when the communication restriction policy satisfied, restricting communications with the mobile device (block 540). As previously mentioned, restricting communications may include one or more of: blocking the communication, recording the communication and/or monitoring the communication, and/or automatically inserting messages in the communications. In one implementation, monitoring a communication may include automatically monitoring the communication for one or more sensitive words (e.g., “merger,” “buy,” etc.). When a communication with sensitive words is detected, a log of the communication may be forwarded to a human for review.

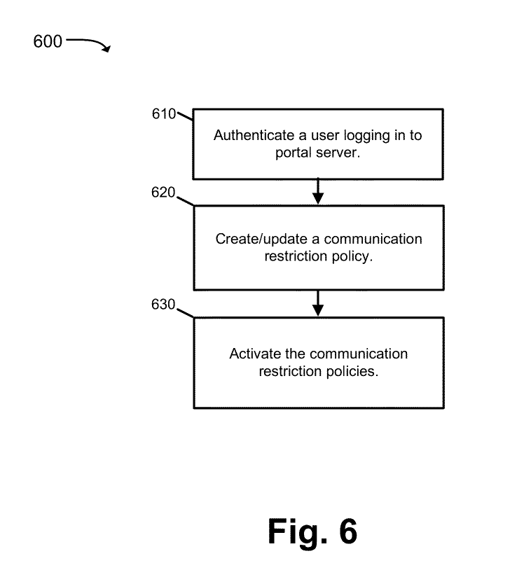

FIG. 6 is a flowchart illustrating an example of a process 600 relating to configuring indication restriction policies for network-based restriction of communications. Process 600 may be performed by, for example, portal server 252.

Process 600 may include authenticating a user logging in to the portal server (block 610). The user may correspond to, for example, an administrator, information technology worker, or other designated user for a company (or other entity) that wishes to restrict communications for employees of the company. Communications may be restricted based on consent of the employee. For example, as a condition to working at the particular company or taking a particular position within the company, the employee may agree that personal communication devices of the employee may be monitored and/or restricted. In some situations, an operator of core network 230 may control or otherwise maintain portal server 252. Portal server 252 may provide a graphical interface or application programming interface (API) through which communication restriction policies may be entered.

Process 600 may further include creating or updating communication restriction policies (block 620). As mentioned, an administrator or other designated user may enter communication restriction policies for mobile devices associated with the company (or other entity) of the administrator. Communication restriction policies may include conditions specified by the administrator. As previously mentioned, the conditions may relate to geographical locations of mobile devices 210, date/time restrictions, and/or conditions based on the occurrence of external events.

Process 600 may further include activating the entered communication restriction policies (block 630). In some implementations, activating a communication instruction policy may include implementing the policy at one or more network devices, such as MME 232, PCRF 238, and/or PGW 236.

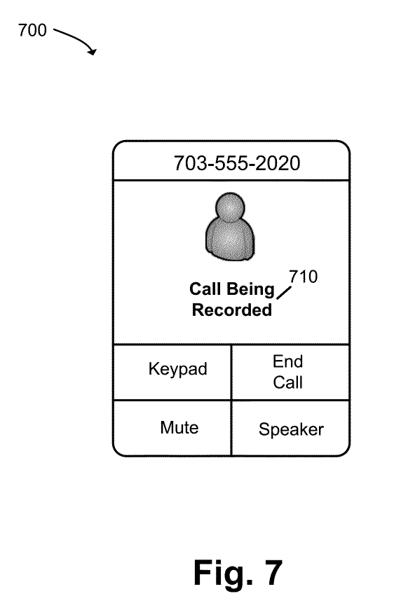

FIG. 7 is a diagram illustrating an example user interface 700 provided by mobile device 210. As previously mentioned, in some implementations, a message, such as an audio or text message, may be provided to one or more participants in a communication session to indicate that the communication session is being blocked, recorded, or monitored. For example, a network device, such as MME 232, PCRF 238, or another device, may cause mobile device 210 to display a message, as part of the interface for the communication session, indicating that the communication session is being blocked, recorded, or monitored. In FIG. 7, user interface 700 may be an example of a user interface that may be provided to a user during a voice call. In this example, message 710 (“Call Being Recorded”) may be provided to the user.

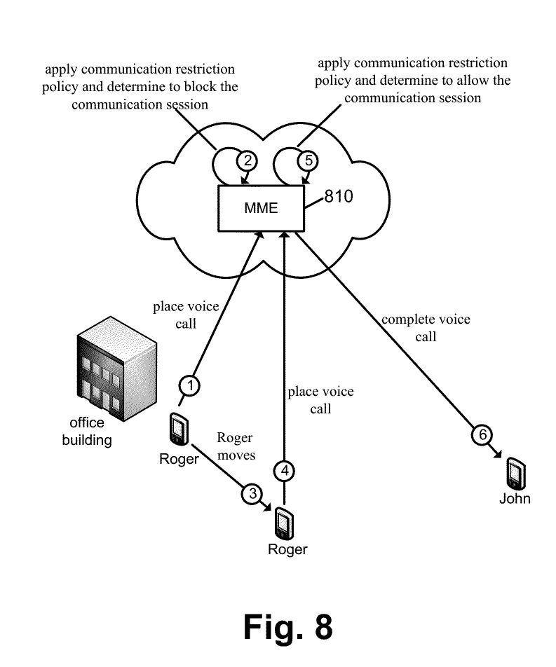

FIG. 8 is a diagram illustrating operations associated with the application of communication restriction policies. As shown in FIG. 8, assume that a user (“Roger”) of a first mobile device initiates a voice call with a second user (“John”) associated with a second mobile device (at “1”, “place voice call”). MME/PCRF 810 may process control signaling relating to the voice call. Additionally, MME/PCRF 810 may determine whether communication restriction policies are in place for the first mobile device, and whether the conditions associated with any such communication restriction policies are satisfied. In this example, assume that a communication restriction policy is associated with the Roger's mobile device and the communication restriction policy is a policy to block voice sessions with other users when the first mobile device is within 100 meters of Roger's assigned office building and the current time is during working hours (e.g., 8 AM through 5 PM). Further, assume that Roger is within 100 meters of the office building. Accordingly, MME/PCRF 810 may determine to block the voice call (at “2”, “apply communication restriction policy and determine to block the communication session”). In this situation, Roger may receive a message indicating that the call cannot be placed due to restrictions placed, by Roger's employer, on voice calls when at the office.

Assume that Roger subsequently moves away from the office building (e.g., greater than 100 meters) (at “3”, “Roger moves”). Roger may then again attempt to place the voice call to John (at “4”, “place voice call”). MME/PCRF 810 may again apply the communication restriction policy. This time, however, because Roger is greater than 100 meters from the office building, the communication restriction policy does not block the voice call (at “5”, “apply communication restriction policy and determine to allow the communication session”). The voice call may thus be completed with John (at “6”, “complete voice call”).

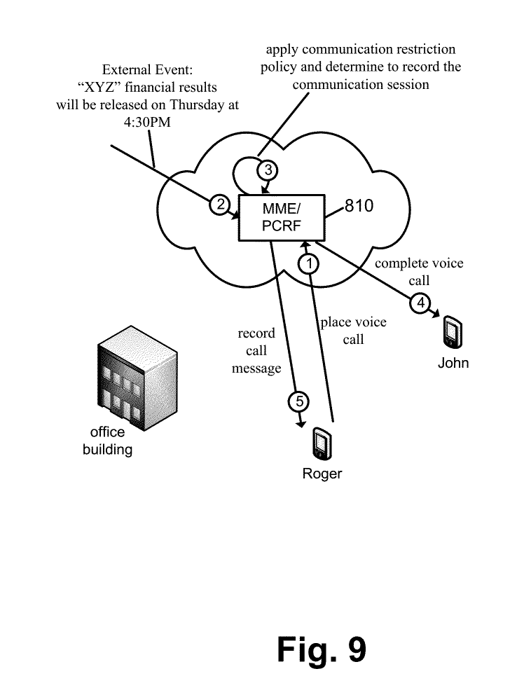

FIG. 9 is a diagram illustrating additional example operations associated with the application of communication restriction policies. As shown in FIG. 9, assume that a user (“Roger”) of a first mobile device initiates a voice call with a second user (“John”) associated with a second mobile device (at “1”, “place voice call”). MME/PCRF 810 may process control signaling relating to the voice call. Additionally, MME/PCRF 810 may determine whether communication restriction policies are in place for the first mobile device, and whether the conditions associated with any such communication restriction policies are satisfied. In this example, assume that a communication restriction policy is associated with the Roger's mobile device and the communication restriction policy is a policy that records voice sessions with other users when financial results, associated with Roger's employer, are scheduled to be released within the next 24 hours.

MME/PCRF 810 may receive an external event, such as from event server 254, indicating when financial results for Roger's employer are scheduled to be released (at “2”, “External Event: ‘XYZ’ financial results will be released on Thursday at 4:30 PM”). Assume that the current date/time is within 24 hours of the release of the financial results. Accordingly, MME/PCRF 810 may determine to record the voice call (at “3”, “apply communication restriction policy and determine to block the communication session”). In this situation, the voice call may be completed (at “4”, “complete voice call”) and Roger (and potentially John) may receive a message indicating that the call is being recorded (at “5”, “record call message”).

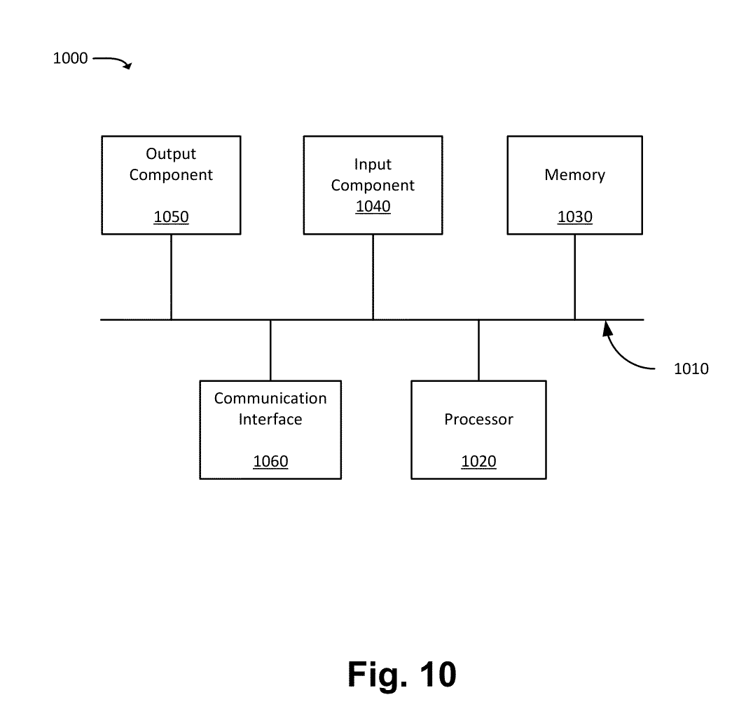

FIG. 10 is a diagram of example components of device 1000. One or more of the devices described above (e.g., with respect to illustrated in FIGS. 1, 2, 8 and/or 9) may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000, such as a keyboard, a keypad, a button, a switch, etc. Output component 1050 may include a mechanism that outputs information to the operator, such as a display, a speaker, one or more light emitting diodes (LEDs), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (IR) receiver, a Bluetooth radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations by processing circuitry, such as in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations. For example, while series of blocks have been described with regard to FIGS. 4-6, the order of the blocks may be modified in other implementations. Further, non-dependent blocks may be performed in parallel.

Additionally, while examples of data structures are illustrated in FIGS. 3A and 3B as including certain types of information, in practice, these data structures may store additional, fewer, different, or differently arranged types of information than shown in these figures. Furthermore, while these data structures are shown as tables, in practice, these data structures may take the form of any other type of data structure, such as an array, a linked list, a hash table, a tree, and/or any other type of data structure.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations are described herein in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms), As used herein, “exceeding” a threshold (or similar terms) may be used interchangeably with “being greater than a threshold,” “being greater than or equal to a threshold.” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. A method implemented by one or more network devices associated with a network, the method comprising:
receiving, by the one or more network devices, a request from a mobile device to establish a communication session;
determining, by the one or more network devices, whether a communication restriction policy is associated with the mobile device;
evaluating, by the one or more network devices and when the communication restriction policy is associated with the mobile device, the communication restriction policy to determine whether conditions associated with the communication restriction policy are satisfied, the conditions including at least one condition relating to an event occurring externally to the network, the event including an expected release of financial information or a news announcement of a particular company; and
restricting, by the one or more network devices and based on the evaluation of the communication restriction policy to determine whether the conditions are satisfied, the communication session.

2. (canceled)

3. The method of claim 1, wherein evaluating whether conditions associated with the communication restriction policy are satisfied include:
determining whether a current location of the mobile device satisfies the conditions with respect to location-based criteria associated with the conditions; and
determining whether a current time satisfies the conditions with respect to time-based criteria associated with the conditions.

4. The method of claim 1, wherein the one or more network devices include a mobility management entity (MME) or a policy and charging rules function (PCRF) associated with a core network of a wireless cellular network.

5. The method of claim 1, wherein evaluating whether conditions associated with the communication restriction policy are satisfied include:
determining whether a location of the mobile device is associated with a work environment of a user of the mobile device; and
determining whether a current time corresponds to working hours of the user.

6. The method of claim 1, wherein restricting the communication session includes:
recording the communication session.

7. The method of claim 1, wherein the method further includes:
causing an audible or visual indication, to be provided by the mobile device, indicating that the communication session is being recorded.

8. A network device, associated with a core network of a wireless network, comprising processing circuitry to:
receive a request from a mobile device to establish a communication session;
determine whether a communication restriction policy is associated with the mobile device;
evaluate, when the communication restriction policy is associated with the mobile device, the communication restriction policy to determine whether conditions associated with the communication restriction policy are satisfied, the conditions including at least one condition relating to an event occurring externally to the wireless network, the event including an expected release of financial information or a news announcement of a particular company; and
record, based on the evaluation of the communication restriction policy to determine whether the conditions are satisfied, the communication session.

9. (canceled)

10. The network device of claim 8, wherein, when evaluating whether conditions associated with the communication restriction policy are satisfied, the processing circuitry is further to:
determine whether a current location of the mobile device satisfies the conditions with respect to location-based criteria associated with the conditions; and
determine whether a current time satisfies the conditions with respect to time-based criteria associated with the conditions.

11. The network device of claim 8, wherein the network device includes a mobility management entity (MME) or a policy and charging rules function (PCRF) device.

12. The network device of claim 8, wherein, when evaluating whether conditions associated with the communication restriction policy are satisfied, the processing circuitry is further to:
determine whether a location of the mobile device is associated with a work environment of a user of the mobile device; and
determine whether a current time corresponds to working hours of the user.

13. The network device of claim 8, wherein the processing circuitry is further to:
cause an audible or visual indication, to be provided by the mobile device, indicating that the communication session is being recorded.

14. A method comprising:
receiving, by a computing device, a communication restriction policy relating to restricting communication sessions of a mobile device, the communication restriction policy including:
a first condition indicating a geographical area within which communication sessions of the mobile device are to be restricted,
a second condition indicating a time constraint during which communication sessions of the mobile device are to be restricted, and
a third condition relating to an occurrence of an event, wherein the event includes one of an expected release of financial information or a news announcement of a particular company; and
providing the communication restriction policy to one or more network devices that provide wireless network connectivity to the mobile device.

15. The method of claim 14, wherein the communication restriction policy is received from an employer of a user of the mobile device, and wherein the communication restriction policy is to limit opportunity, of the user, to disclose material non-public information relating to the employer.

16. The method of claim 14, wherein the communication restriction policy further includes:
actions to take to restrict the communication sessions of a mobile device, the actions including:
recording the communication sessions.

17. The method of claim 16, wherein the method further includes:
causing an audible or visual indication, to be provided by the mobile device, indicating that the communication session is being restricted.

18. (canceled)

19. (canceled)

20. The method of claim 14, wherein the one or more network devices include a mobility management entity (MME) or a policy and charging rules function (PCRF) associated with network that provides the wireless network connectivity to the mobile device.

21. The method of claim 1, wherein the communication session includes a voice or video call.

22. The network device of claim 8, wherein the communication session includes a voice or video call.

23. The method of claim 14, wherein the communication sessions include voice or video calls.

24. The method of claim 1, wherein the event additionally includes unusual price changes in a publically traded security of the particular company.
